(19) United States
(12) Patent Application Publication
(10) Pub. No.: US 2020/0256133 A1
(43) Pub. Date: Aug. 13, 2020

(54) SUPERABRASIVE COMPACTS, METHODS OF MAKING THE SAME, AND APPARATUSES USING THE SAME

(71) Applicant: US SYNTHETIC CORPORATION, Orem, UT (US)

(72) Inventors: Anne-Grethe Slotnaes, South Jordan, UT (US); Daniel Scott, Provo, UT (US); Debkumar Mukhopadhyay, Sandy, UT (US); Jeremy B. Lynn, Nephi, UT (US); Jiang Qian, Cedar Hills, UT (US)

(21) Appl. No.: 16/787,214

(22) Filed: Feb. 11, 2020

Related U.S. Application Data
(60) Provisional application No. 62/804,801, filed on Feb. 13, 2019.

(51) Int. Cl. E21B 10/567; F16C 33/12

(52) U.S. Cl. CPC E21B 10/567; F16C 33/121; F16C 2352/00; F16C 2240/60; F16C 2206/82; F16C 2206/56; F16C 2206/04

(57) ABSTRACT

Embodiments disclosed herein relate to superabrasive compacts, methods of making the same, and drill bits incorporating the same. For example, embodiments of a superabrasive compact disclosed herein (e.g., a PDC) may be formed by providing a superabrasive compact. The superabrasive compact includes a superabrasive body and a cemented carbide substrate bonded to the superabrasive body. The cemented carbide substrate includes a base surface, an interfacial surface bonded to the superabrasive body, and at least one peripheral surface extending between the base surface and the interfacial surface. After providing the superabrasive compact, the method includes lasing at least a portion of the peripheral surface of the cemented carbide substrate to form a corrosion-resistant layer

### CROSS-REFERENCE TO RELATED APPLICATIONS

This application claims priority to U.S. Patent Application No. 62/804,801 filed 13 Feb. 2019, the disclosure of which is incorporated herein, in its entirety, by this reference.

### BACKGROUND

Wear-resistant, superabrasive compacts are utilized in a variety of mechanical applications. For example, polycrystalline diamond compacts (“PDCs”) are used in drilling tools (e.g., cutting elements, gage trimmers, etc.), machining equipment, bearing apparatuses, wire-drawing machinery, and in other mechanical apparatuses.

PDCs have found particular utility as superabrasive cutting elements in rotary drill bits, such as roller cone drill bits and fixed cutter drill bits. A PDC cutting element typically includes a superabrasive diamond layer commonly referred to as a polycrystalline diamond table. The polycrystalline diamond table is formed and bonded to a substrate using a high-pressure/high-temperature (“HPHT”) process.

A fixed-cutter rotary drill bit typically includes a number of PDC cutting elements affixed to the bit body. PDC cutting elements are typically brazed directly into a preformed recess formed in a bit body of a fixed-cutter rotary drill bit. In some applications, the substrate of the PDC cutting element may be brazed or otherwise joined to an attachment member (e.g., a cylindrical backing), which may be secured to a bit body by press-fitting or brazing.

Superabrasive compacts may include a superabrasive body bonded to a cemented carbide substrate. During use of the superabrasive compacts, such as use of the superabrasive compacts in a drill bit, the cemented carbide substrate may experience deterioration due to corrosion. For example, the superabrasive compacts may be exposed to corrosive agents (e.g., drilling fluid) that cause the cementing constituent (e.g., cobalt) of the cemented carbide substrate to be removed from the cemented carbide substrate. The cementing constituent may be one of the primary means of bonding the carbide grains of the cemented carbide substrate together. As such, removing of the cementing constituent may weaken the cemented carbide substrate and, by extension, the superabrasive compact.

Manufacturers and users of superabrasive elements, such as PDCs, continue to seek improved processing techniques.

### SUMMARY

Embodiments disclosed herein relate to superabrasive compacts, methods of making the same, and drill bits incorporating the same. For example, embodiments of a superabrasive compact disclosed herein (e.g., a PDC) may be formed by providing a superabrasive compact. The superabrasive compact includes a superabrasive body and a cemented carbide substrate bonded to the superabrasive body. The cemented carbide substrate includes a base surface, an interfacial surface bonded to the superabrasive body, and at least one peripheral surface extending between the base surface and the interfacial surface. After providing the superabrasive compact, the method includes lasing at least a portion of the peripheral surface of the cemented carbide substrate to form a corrosion-resistant layer.

In an embodiment, a superabrasive compact is disclosed. The superabrasive compact includes a superabrasive body including an upper surface, a bonding surface, and at least one lateral surface extending between the upper surface and the bonding surface. The superabrasive compact also includes a cemented carbide substrate including at least one cementing constituent. The cemented carbide substrate includes a base surface, an interfacial surface bonded to the bonding surface of the superabrasive body, at least one peripheral surface extending between the base surface and the interfacial surface, and a corrosion-resistant layer extending inwardly from a portion of the at least one peripheral surface. The corrosion-resistant layer includes a lower concentration of the at least one cementing constituent than portions of the cemented carbide substrate that are spaced from the corrosion-resistant layer.

In an embodiment, a method of making a corrosion-resistant superabrasive compact is disclosed. The method includes providing a superabrasive compact. The superabrasive compact includes a superabrasive body having an upper surface, a bonding surface, and at least one lateral surface extending between the upper surface and the bonding surface. The superabrasive compact also includes a cemented carbide substrate having a base surface, an interfacial surface bonded to the bonding surface, and at least one peripheral surface extending between the base surface and the interfacial surface. The cemented carbide substrate also at least one cementing constituent. The method further includes lasing a portion of the at least one peripheral surface of the cemented carbide substrate to form a corrosion-resistant layer extending into the at least one peripheral surface. The corrosion-resistant layer includes a lower concentration of the at least one cementing constituent than portions of the cemented carbide substrate that are spaced from the corrosion-resistant layer.

In an embodiment, a drill bit is disclosed. The drill bit includes a bit body and a superabrasive compact attached to the bit body. The superabrasive compact includes a superabrasive body including an upper surface, a bonding surface, and at least one lateral surface extending between the upper surface and the bonding surface. The superabrasive compact also includes a cemented carbide substrate including at least one cementing constituent. The cemented carbide substrate includes a base surface, an interfacial surface bonded to the bonding surface of the superabrasive body, at least one peripheral surface extending between the base surface and the interfacial surface, and a corrosion-resistant layer extending inwardly from at least portions of the at least one peripheral surface that are not covered by the bit body. The corrosion-resistant layer includes a lower concentration of the at least one cementing constituent than portions of the cemented carbide substrate that are spaced

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIGS. 1A and 1B are isometric and cross-sectional views, respectively, of a superabrasive compact, according to an embodiment.

FIG. 2 is a cross-sectional view of a superabrasive compact during a lasing process to form a corrosion-resistant layer, according to an embodiment.

FIGS. 3A-3D are isometric views of superabrasive compacts, according to different embodiments.

FIGS. 4A-4E are views of different superabrasive compacts that include one or more features thereon, according to different embodiments.

FIG. 5 is a cross-sectional view of an application in which a superabrasive compact is attached to a support body, according to an embodiment.

FIG. 6A is an isometric view and FIG. 6B is a top elevation view of an embodiment of a rotary drill bit, according to an embodiment.

FIG. 7 is a graph illustrating an amount of mass loss of superabrasive compacts of comparative example and working example 1.

FIG. 8 is a graph of an X-ray diffraction analysis of a cobalt-cemented tungsten carbide substrate of working example 2.

### DETAILED DESCRIPTION

Embodiments disclosed herein relate to superabrasive compacts, methods of making the same, and drill bits incorporating the same. For example, embodiments of a superabrasive compact disclosed herein (e.g., a PDC) may be formed by providing a superabrasive compact. The superabrasive compact includes a superabrasive body and a cemented carbide substrate bonded to the superabrasive body. The cemented carbide substrate includes a base surface, an interfacial surface bonded to the superabrasive body, and at least one peripheral surface extending between the base surface and the interfacial surface. After providing the superabrasive compact, the method includes lasing at least a portion of the peripheral surface of the cemented carbide substrate to form a corrosion-resistant layer.

The corrosion-resistant layer formed according to embodiments the methods disclosed herein improves the corrosion resistance of the cemented carbide substrate and, by extension, the superabrasive compact. The corrosion-resistance layer improves the corrosion resistance of the cemented carbide substrate because lasing the cemented carbide substrate, as disclosed herein, may change properties and/or microstructure of the cemented carbide substrate. In an embodiment, lasing the cemented carbide substrate may at least partially remove (e.g., via ablation and/or evaporation) at least some of the at least one cementing constituent (e.g., cobalt) from the cemented carbide substrate. For example, lasing the cemented carbide substrate may remove substantially all of the cementing constituent from a portion of the corrosion-resistant layer. In an embodiment, prior to lasing, the cemented carbide substrate includes a plurality of carbide grains defining interstitial regions therebetween that are at least partially occupied by the cemented constituent. Lasing the cemented carbide substrate may potentially promote grain growth between the plurality of carbide grains. Such grain growth between the carbide grains may improve bonding between the carbide grains (e.g., decreases the reliance on the cementing constituent to hold the carbide grains together) and may reduce an average diameter of the interstitial regions that are at least at and/or near the peripheral surface of the cemented carbide substrate. The reduced average diameter may make it more difficult for the cementing constituents that are within the interstitial regions to be exposed to a corrosive environment. In an embodiment, lasing the cemented carbide substrate may cause the corrosion-resistant layer to exhibit a selected surface texture (e.g., surface roughness) that inhibits corrosion of the cemented carbide substrate. In an embodiment, lasing the cemented carbide substrate may change the chemistry of the corrosion-resistant layer and the change in chemistry may inhibit corrosion of the cemented carbide substrate. Combinations of the above-described mechanisms may occur due to lasing the cemented carbide substrate.

While the description herein provides examples relative to a drill bit assembly, the superabrasive compact embodiments disclosed herein may be used in any number of applications. For instance, superabrasive compacts disclosed herein may be used in a bearing apparatus, machining equipment, molding equipment, wire dies, thrust or radial bearings, artificial joints, inserts, heat sinks, and other articles and apparatuses, or in any combination of the foregoing.

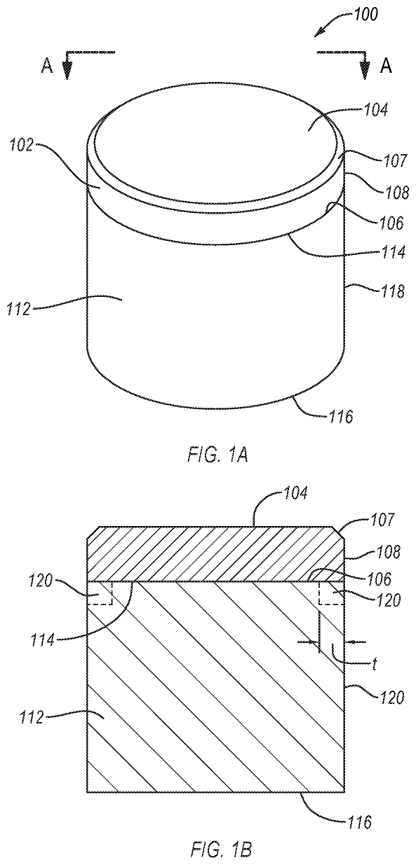

FIGS. 1A and 1B are isometric and cross-sectional views, respectively, of a superabrasive compact 100, according to an embodiment. The superabrasive compact 100 includes a superabrasive body 102 bonded to a cemented carbide substrate 112. The superabrasive body 102 may include an upper surface 104, a bonding surface 106, at least one lateral surface 108 extending between the upper surface 104 and the bonding surface 106, and optionally, a chamfer 107 extending between the upper surface 104 and the lateral surface 108. The cemented carbide substrate 112 includes an interfacial surface 114, a base surface 116 spaced from the interfacial surface 114, and at least one peripheral surface 118 extending between the interfacial surface 114 and the base surface 116.

In the illustrated embodiment, the superabrasive compact 100 is substantially cylindrical and the peripheral surface 118 is substantially continuous. However, in other embodiments, the superabrasive compact 100 may be non-cylindrical. Other shapes or configurations of a suitable superabrasive compact may include elliptical, rectangular, triangular, or other suitable configuration. Thus, in some embodiments, the peripheral surface 118 of the cemented carbide substrate 112 may be defined by multiple surfaces. Additionally, although the interfacial surface 114 is depicted as being substantially planar, in other embodiments, the interfacial surface 114 may exhibit a selected non-planar (e.g., domed) topography.

The cemented carbide substrate 112 may include a plurality of carbide grains. The carbide grains may include tungsten carbide, titanium carbide, chromium carbide, niobium carbide, tantalum carbide, vanadium carbide, or combinations thereof. The carbide grains may be bonded (e.g., weakly bonded) together. The cemented carbide substrate 112 also includes at least one cementing constituent to improve the bonding between the carbide grains. The cementing constituent may include, for example, iron, nickel, cobalt, or alloys thereof. The cementing constituent may be selected based on the desired corrosion resistance of the cemented carbide substrate 112. For example, the cementing constituent may be selected to comprise nickel, a nickel-based alloy, iron, or an iron-based alloy when the superabrasive compact 100 is used in corrosive environments since these materials may exhibit better corrosion resistance than cobalt or cobalt-based alloys. However, it is noted that cemented carbide substrate 112 may include cobalt or at least one cobalt-based alloy when the cemented carbide substrate 112 is configured to be used in corrosive environments due to the corrosion-resistant layer 120. In an embodiment, the cemented carbide substrate 112 comprises cobalt-cemented tungsten carbide. Examples of cemented carbide substrates that may be used herein and methods of processing the cemented carbide substrates disclosed herein are disclosed in U.S. Pat. No. 9,732,563 filed on Jul. 30, 2013 and U.S. Provisional Patent Application No. 62/730,137 filed on Sep. 12, 2018, the disclosures of each of which are incorporated herein, in its entirety, by this reference.

As shown in FIGS. 1A and 1B, the bonding surface 106 of the superabrasive body 102 of the superabrasive compact 100 may be bonded to the interfacial surface 114 of the cemented carbide substrate 112. One or more of the upper surface 104, the lateral surface 108, or the chamfer 107 may function as a cutting or bearing surface.

The superabrasive body 102 may comprise one or more superabrasive materials. For example, the superabrasive body 102 may include natural diamond, sintered polycrystalline diamond (“PCD”), polycrystalline cubic boron nitride, diamond grains bonded together with silicon carbide, or combinations of the foregoing. In an embodiment, the superabrasive body 102 is a PCD table that includes a plurality of directly bonded-together diamond grains exhibiting diamond-to-diamond bonding therebetween (e.g., sp³ bonding), which define a plurality of interstitial regions. A portion of or substantially all of the interstitial regions of such a superabrasive body 102 may include a metal-solvent catalyst, a metallic infiltrant disposed therein that is infiltrated from the cemented carbide substrate 112 or from another source. For example, the metal-solvent catalyst or metallic infiltrant may be selected from iron, nickel, cobalt, and alloys of the foregoing. The superabrasive body 102 may further include a thermally-stable diamond region in which the metal-solvent catalyst or metallic infiltrant has been partially or substantially completely depleted from such selected region (e.g., along one or more surfaces or volumes) of the superabrasive body 102 using, for example, an acid leaching process.

In an embodiment, the superabrasive body 102 may be integrally formed with the cemented carbide substrate 112. For example, the superabrasive body 102 may be a sintered PCD table that is integrally formed with the cemented carbide substrate 112. In such an embodiment, the infiltrated metal-solvent catalyst may be used to catalyze formation of diamond-to-diamond bonding between diamond grains of the superabrasive body 102 from diamond powder during HPHT processing. In an embodiment, the superabrasive body 102 may be a preformed superabrasive body (e.g., a preformed PCD table) that has been HPHT bonded to the cemented carbide substrate 112 in a second HPHT process after being initially formed in a first HPHT process. For example, the superabrasive body 102 may be a preformed PCD table that has been leached to substantially completely remove metal-solvent catalyst used in the initial manufacture thereof and subsequently HPHT bonded or brazed to the cemented carbide substrate 112 in a separate process.

As discussed herein, in some embodiments, the superabrasive body 102 may be leached to deplete a metal-solvent catalyst or a metallic infiltrant therefrom in order to enhance the thermal stability of the superabrasive body 102. The superabrasive body 102 may be leached before or after forming the corrosion resistant layer 120 on the substrate 112. For example, when the superabrasive body 102 is a PCD table, the superabrasive body 102 may be leached to remove at least a portion of the metal-solvent catalyst from a region thereof to a selected depth that was used to initially sinter the diamond grains to form a leached thermally-stable region. The leached thermally-stable region may extend inwardly from one or more of the upper surface 104, the lateral surface 108, and the chamfer 107 to a selected depth. Generally, the leached thermally-stable region extends from the upper surface 104 along only part of the height of the superabrasive body 102, as leaching at the interface between the cemented carbide substrate 112 and the superabrasive body 102 may deplete cobalt or another metal-solvent catalyst or metallic infiltrant, thereby weakening the bond between the cemented carbide substrate 112 and the superabrasive body 102. Thus, in a leaching process, the cemented carbide substrate 112 and an interior portion of the superabrasive body 102 may remain relatively unaffected. In one example, the selected depth may be about 10 μm to about 1,200 μm. More specifically, in some embodiments, the selected depth is about 50 μm to about 100 μm or about 500 μm to about 1200 μm. The leaching may be performed in a suitable acid, such as aqua regia, nitric acid, hydrofluoric acid, or mixtures of the foregoing. Additional examples of leaching the superabrasive compact 100 are disclosed in U.S. Pat. No. 9,844,854 filed on Nov. 19, 2013, U.S. Pat. No. 9,144,886 filed on Aug. 14, 2012, U.S. Pat. No. 9,702,198 filed on Mar. 6, 2014, and U.S. Pat. No. 9,550,276 filed on Jun. 18, 2013, the disclosure of each of which are incorporated herein, in its entirety, by this reference.

In an embodiment, the corrosion-resistant layer 120 is formed on the cemented carbide substrate 112 before leaching the superabrasive body 102. The corrosion-resistant layer 120 may facilitate leaching the superabrasive body 102. In an example, the corrosion-resistant layer 120 may allow the superabrasive body 102 to be leached without masking the cemented carbide substrate 112, disposing the cemented carbide substrate 112 in a leaching cup that is configured to substantially prevent the cemented carbide substrate 112 from being exposed to the acid, or otherwise protecting the cemented carbide substrate 112 from the acid. In an example, the corrosion-resistant layer 120 may inhibit damage to the cemented carbide substrate 112 by acid that inadvertently reached the cemented carbide substrate 112 through the mask or the leaching cup.

In some embodiments, the cemented carbide substrate 112 may be bonded to a PCD superabrasive body 102. Such structures may be fabricated by subjecting diamond particles, placed on or proximate to the cemented carbide substrate 112, to an HPHT sintering process. The diamond particles with the cemented carbide substrate 112 may be HPHT sintered at a temperature of at least about 1000° Celsius (e.g., about 1100° C. to about 1600° C.) and a cell pressure of at least about 4 GPa (e.g., about 5 GPa to about 9 GPa, or about 7 GPa or more) for a time sufficient to consolidate and form a coherent mass of bonded diamond grains. In such a process, the cobalt or other metal-solvent catalyst from the cemented carbide substrate 112 may sweep into interstitial regions between the diamond particles to catalyze growth of diamond between the diamond particles. More particularly, following HPHT processing the superabrasive body 102 may comprise a matrix of diamond grains that are bonded with each other via diamond-to-diamond bonding and the interstitial regions between the diamond grains may be at least partially occupied by cobalt or other metal-solvent catalyst that has been swept in, thereby creating a network of diamond grains with interposed cobalt or other metal-solvent catalyst.

In some embodiments, PCD tables and/or PDCs may be formed at ultra-high-pressure and/or high-temperatures (e.g., cell pressures above about 7.5 GPa cell pressure and/or temperatures above about 1000° C.). The PCD table so formed may exhibit lower residual compressive stress therein and the cemented carbide substrate 112 may exhibit lower residual tensile stress therein than a PDC formed at cell pressures below 7.5 GPa. Such PCDs and PDCS and methods for making the same are disclosed in U.S. Pat. Nos. 7,866,418, 8,297,382, and U.S. patent application Ser. No. 15/131,687, the disclosure of each of which are incorporated herein, in their entirety, by this reference.

Referring to FIG. 1B, the cemented carbide substrate 112 includes a corrosion-resistant layer 120 formed therein. For example, the corrosion-resistant layer 120 may extend inwardly from the peripheral surface 118. The corrosion-resistant layer 120 may allow the superabrasive compact 100 to be used in corrosive environments and/or increase the lifespan of the superabrasive compact 100 in the corrosive environments. For example, the corrosion-resistant layer 120 may exhibit a corrosion penetration rate that is at least two time less than the rest of the cemented carbide substrate 112 when exposed to the same corrosive environment (e.g., the corrosive environment that is present during drilling applications), such as a corrosion penetration rate that is at least about 3 times less, at least about 4 times less, at least about 5 times less, at least about 6 times less, at least about 7 times less, at least about 8 time less, at least about 9 times less, or even at least about 10 times less than the rest of the cemented carbide substrate 112.

A corrosion test for determining the corrosion penetration rate may include measuring an initial mass of a test element. As used herein, the test element may include at least one of the cemented carbide substrate 112 that includes the corrosion-resistant layer 120, a substantially similar cemented carbide substrate that does not include the corrosion-resistant layer 120, a superabrasive body 102 that includes the cemented carbide substrate 112 with the corrosion-resistant layer 120 bonded thereto, or a substantially similar superabrasive body that includes a substantially similar cemented carbide substrate without a corrosion-resistant layer bonded thereto. The corrosion test may then include disposing the test element in oxidative and/or corrosive conditions (e.g., an acid solution) for a period of time. The test element is then removed from the oxidative and/or corrosive conditions and the mass of the test element is measured. In an example, the test element is grit blasted (e.g., with steel grit, silicon carbide grit, silicon oxide grit, or another suitable grit) or subjected to another process that removes oxides and other contaminants from the test element. The decrease of mass of the test element directly correlates to the corrosion penetration rate.

In an embodiment, the corrosion test may include using an oxidative assay to determine the corrosivity of the test element. The corrosion test may include a three electrode set-up (e.g., potentiostat) that includes the test element as the working electrode, a counter electrode (e.g., a platinum wire), and a reference electrode (e.g., a silver/silver chloride electrode). The oxidative assay includes a buffered solution as the electrolyte. The buffered solution may be made with about 0.1 molar (“M”) to about 2.0 M salt. The salt may include at least one of sodium chloride, sodium fluoride, potassium chloride, potassium nitrate, magnesium chloride, or another suitable salt. The buffered solution is buffered with about 0.2 M to about 2 M buffer agent. The buffer agent may include a salt of at least one of phosphate, carbonate, acetate, trisaminomethane, citrate, formate, or other suitable compound. The pH of the buffered solution may range from about 4.0 to about 12.0. The conductivity of the buffered solution may range from 0.1 to 200 milli-seimens. The corrosion test may include placing the test element in a container that includes the buffered solution. The test element is electrically contacted with the counter electrode. An oxidative potential between −0.3 volts and 2.0 volts is applied to the test element for about 10 seconds to about 600 seconds. The test element is then removed from the container and grit blasted. The mass of the test element is taken before and after the corrosion test. The amount of mass of the test element that is lost relates directly to the rate of corrosion of the test element.

In an embodiment, the corrosion penetration rate of the corrosion-resistant layer 120 of the cemented carbide substrate 112 relative to the rest of the cemented carbide substrate 112 may be determined by performing a corrosion test on the cemented carbide substrate 112 and comparing the mass loss of the corrosion-resistant layer 120 relative to the other portions of the exterior surface of the cemented carbide substrate 112 that does not include the corrosion-resistant layer 120. In an embodiment, the corrosion penetration rate of the corrosion-resistant layer 120 of the cemented carbide substrate 112 relative to the rest of the cemented carbide substrate 112 may be determined by performing a corrosion test on the cemented carbide substrate 112. The corrosion test may be performed while portions of the cemented carbide substrate 112 are masked or otherwise protected from the oxidative and/or corrosive conditions. In such an embodiment, a substantially similar cemented carbide substrate that does not include a corrosion-resistant layer may have the same corrosion test performed thereon while only surfaces of the substantially similar cemented carbide substrate that correspond to un-masked surface of the cemented carbide substrate 112 are exposed to the oxidative and/or corrosive conditions.

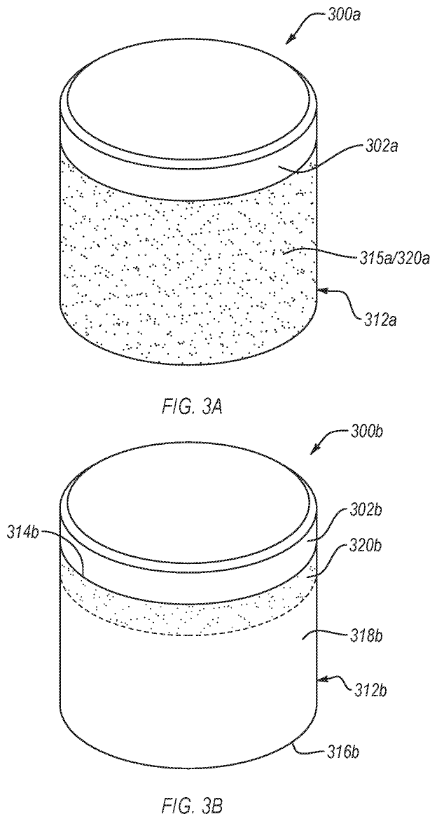

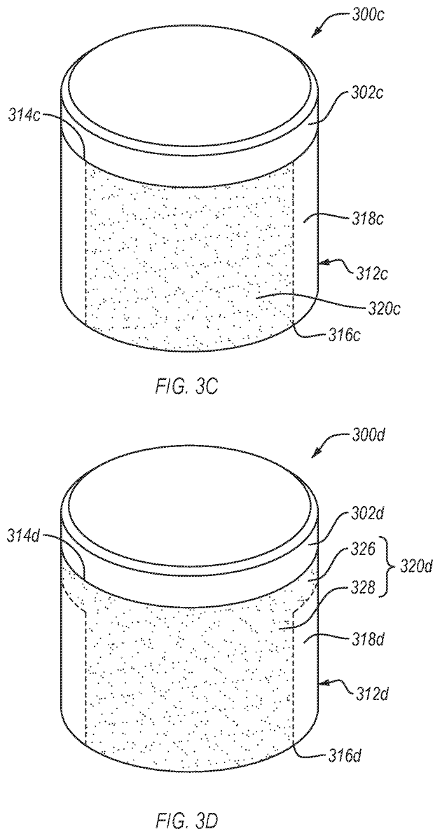

As will be discussed in more detail below, the corrosion-resistant layer 120 is formed by lasing at least a portion of the peripheral surface 118. For example, lasing the peripheral surface 118 may include merely lasing a portion of the peripheral surface 118 (as shown) or lasing all or substantially all of the peripheral surface 118 (as shown in FIG. 3A). As previously discussed, lasing the peripheral surface 118 to form the corrosion-resistant layer 120 changes the microstructure and/or properties of the corrosion-resistant layer 120.

In an embodiment, lasing the peripheral surface 118 may remove at least some of a cementing constituent from the corrosion-resistant layer 120. For example, lasing the peripheral surface 118 may remove at least about 25 weight percent (“wt. %”), at least about 50 wt. %, at least about 75 wt. %, at least about 90 wt. %, at least about 95 wt. %, or at least 99 wt. % of the cementing constituent from the corrosion-resistant layer 120. For example, lasing the peripheral surface 118 may remove substantially all of the cementing constituent from at least a portion of the corrosion-resistant layer 120. For instance, lasing the peripheral surface 118 may remove substantially all of the cementing constituent to a depth that extends inwardly from the peripheral surface that is at least about 1 μm, at least about 2 μm, at least about 3 μm, at least about 4 μm, at least about 5 μm, at least about 10 μm, or in ranges of about 1 μm to about 5 μm, about 3 μm to about 7 μm, about 5 μm to about 10 μm, about 7 μm to about 15 μm, or about 10 μm to about 20 μm. Removing the cementing constituent from the corrosion-resistant layer 120 may prevent or inhibit dissolution of the cementing constituent from the corrosion-resistant layer 120 since the amount of the cementing constituent that may be removed from the corrosion-resistant layer 120 may be reduced.

While not being bound to any particular theory, in an embodiment, lasing the peripheral surface 118 may improve the corrosion resistance of the cemented carbide substrate 112 by enhancing bonding between the carbide grains (e.g., promoting carbide grain growth). Enhancing the bonding between the carbide grains may reduce the average diameter of the interstitial regions between the carbide grains. For example, the average diameter of the interstitial regions of at least a portion the corrosion-resistant layer 120 (e.g., portions of the corrosion-resistant layer 120 at and/or near the peripheral surface 118) may be smaller than the average diameter of the interstitial regions of a portion of the cemented carbide substrate 112 that is spaced from the corrosion-resistant layer 120 by about 1% to about 99%, such as in ranges of about 1% to about 20%, about 10% to about 30%, about 20% to about 40%, about 30% to about 50%, about 40% to about 60%, about 50% to about 70%, about 60% to about 80%, about 70% to about 90%, or about 80% to about 99%.

While not being bound to any particular theory, in an embodiment, lasing the peripheral surface 118 may improve the corrosion resistance of the cemented carbide substrate 112 by changing a surface texture (e.g., surface roughness) of the peripheral surface 118. For example, lasing the peripheral surface 118 may include causing the corrosion-resistant layer 120 to exhibit a surface roughness of about 100 μm to about 500 μm, about 75 μm to about 150 μm, about 50 μm to about 100 μm, about 25 μm to about 75 μm, about 15 μm to about 30 μm, about 10 μm to about 20 μm, about 5 μm to about 15 μm, about 3 μm to about 6 μm, about 2 μm to about 4 μm, about 1 μm to about 3 μm, about 750 nm to about 1.5 μm, or less that about 1 μm. It is noted that, as used herein, surface roughness may refer to either the root mean square surface roughness (Rrms) or the arithmetical mean deviation surface roughness (Ra), without limitation. In an example, lasing the peripheral surface 118 may decrease the surface roughness of the peripheral surface 118. Decreasing the surface roughness of the peripheral surface 118 may increase the contact angle between the corrosion-resistant layer 120 and a corrosive agent in a corrosive environment. The increased contact angle may make it more difficult for the corrosive agent to penetrate the cemented carbide substrate 112 and remove the cementing constituent from the cemented carbide substrate 112. In an example, the surface roughness of the peripheral surface 118 may be less than a portion of the peripheral surface 118 that is spaced from the corrosion-resistant layer 120 by at least about 5%, such as in ranges of about 5% to about 20%, about 10% to about 30%, about 25% to about 50%, about 40% to about 80%, about 75% to about 150%, about 100% to about 200%, about 150% to about 300%, about 250% to about 500%, about 400% to about 800%, about 750% to about 1500%, or more than about 1000%. It is noted that, depending on the composition of the cemented carbide substrate 112 and the composition of the corrosive agent, increasing the surface roughness (instead of decreasing the surface roughness) of the peripheral surface 118 may increase the contact angle. As such, in some embodiments, lasing the peripheral surface 118 may include increasing the surface roughness of the peripheral surface 118.

While not being bound to any particular theory, in an embodiment, lasing the peripheral surface 118 may improve the corrosion resistance of the cemented carbide substrate 112 by changing the chemical composition of the corrosion-resistant layer 120 relative to the rest of the cemented carbide substrate 112. Changing the chemical composition of the cemented may improve the corrosion resistance of the cemented carbide substrate 112 (e.g., increase a contact angle between the corrosion-resistant layer 120 and a corrosive agent in the corrosive environment). In an example, lasing the peripheral surface 118 may change the ratio of the metal to carbon in at least some of the carbide grains, such as reduce the number of carbon atoms relative to the metal. For example, when the cemented carbide substrate 112 includes tungsten carbide, lasing the peripheral surface 118 may change the chemical composition of some of the tungsten carbide grains from WC to WC₁₋ₓ, where x is less than one. In an example, lasing the peripheral surface 118 may form metal oxides.

The corrosion-resistant layer 120 may exhibit a thickness t that extends inwardly from the peripheral surface 218. The thickness t may be substantially constant (e.g., vary by at most 25%, at most 10%, or at most 5%) or may be controllably vary. In an embodiment, the thickness t may be at least about 500 nm, such as at least about 1 μm, at least about 4 μm, at least about 10 μm, at least about 25 μm, or in ranges of about 500 nm to about 1 μm, about 750 nm to about 1.5 μm, about 1 μm to about 3 μm, about 2 μm to about 4 μm, about 3 μm to about 5 μm, about 4 μm to about 6 μm, about 5 μm to about 8 μm, about 7 μm to about 10 μm, about 8 μm to about 12 μm, about 10 μm to about 15 μm, about 12 μm to about 17 μm, about 15 μm to about 20 μm, about 17 μm to about 25 μm, about 20 μm to about 30 μm, about 25 μm to about 35 μm, about 30 μm to about 40 μm, about 35 μm to about 45 μm, or about 40 μm to about 50 μm. The thickness t of the corrosion-resistant layer 120 may be selected based on the desired corrosion resistance of the cemented carbide substrate 112. For example, increasing the thickness t of the corrosion-resistant layer 120 may generally increase the corrosion resistance of the cemented carbide substrate 112. However, increasing the thickness t may also increase the complexity of the process of forming the corrosion-resistant layer 120.

In an embodiment, the peripheral surface 118 of the cemented carbide substrate 112 includes a native oxide layer that is distinct from the corrosion-resistant layer 120. The native oxide layer is an oxide layer formed on the peripheral surface 118 without using lasers and, as such, the native oxide layer may be distinct from the corrosion-resistant layer 120. Further, the corrosion-resistant layer 120 exhibits several properties and/or microstructures that are different than the native oxide layer. In an example, the corrosion-resistant layer 120 exhibits a thickness t that is at least about 10% greater than the native oxide layer, such as at least about 25% greater, at least about 50% greater, at least about 100% greater, at least about 200% greater, at least about 500% greater, or at least about 1000% greater. In an example, except for the presence of one or more metal oxides, the native oxide layer exhibits substantially the same properties of the portions of the cemented carbide substrate 112 that are spaced from the corrosion-resistant layer 120. As such, the corrosion-resistant layer 120 may exhibit at least one of a cementing constituent content that is less than the native oxide layer by any of the ranges disclosed herein, an average pore diameter that is less than the native oxide layer by any of the ranges disclosed herein, a chemistry that is different than the native oxide layer, or any of the other differences disclosed herein.

In an embodiment, the corrosion-resistant layer 120 may also inhibit liquid metal embrittlement. Examples of liquid metal embrittlement are disclosed in U.S. Pat. No. 8,863,864 filed on May 26, 2011, the disclosure of which is incorporated herein, in its entirety, by this reference.

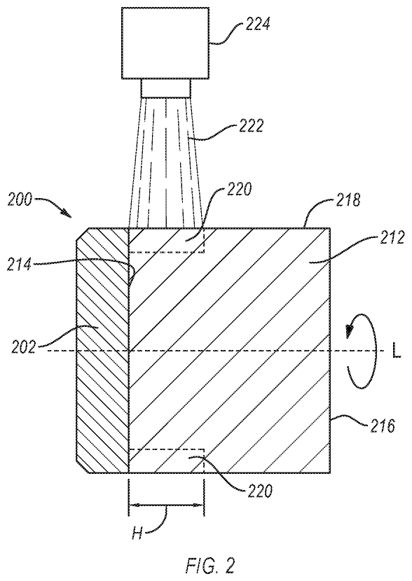

FIG. 2 is a cross-sectional view of a superabrasive compact 200 during a lasing process to form a corrosion-resistant layer 220, according to an embodiment. The lasing process illustrated in FIG. 2 begins by providing the superabrasive compact 200. Except as otherwise disclosed herein, the superabrasive compact 200 may be the same or substantially similar to any of the superabrasive compact embodiments disclosed herein. For example, the superabrasive compact 200 may include a superabrasive body 202. The superabrasive compact 200 may also include a cemented carbide substrate 212 that includes an interfacial surface 214 bonded to the superabrasive body 202, an opposing base surface 216, and at least one peripheral surface 218 extending between the interfacial surface 214 and the base surface 216. In an embodiment, providing the superabrasive compact 200 may include forming the superabrasive compact 200, such as forming the superabrasive compact 200 in an HPHT process.

Lasing at least a portion of the peripheral surface 218 of the cemented carbide substrate 212 to form the corrosion-resistant layer 220 may include emitting one or more laser beams 222 from a laser 224. The laser 224 may include a fiber laser (e.g., ytterbium fiber laser), a carbon dioxide or carbon monoxide laser, a YAG laser (e.g., a Yb:YAG laser), a semi-conductor laser, a continuous wave laser (e.g., a laser having a continuous wave mode), a pulsed laser, a scanning laser, or any other suitable laser. Lasing the peripheral surface 218 may heat the discrete portions of the peripheral surface 218. Heating discrete portions of the peripheral surface 218 with the laser beams 222 may cause at least one of the following: removal at least one cementing constituent from the cemented carbide substrate 212, promote grain growth of the carbide grains of the cemented carbide substrate 212, reduce the average diameter of the interstitial regions between the carbide grains, selectively change the surface texture of the peripheral surface 218, or change the chemical composition of the cemented carbide substrate 212.

In an embodiment, the spot size of the laser beam 222 may be less than about 10 μm, such as less than 5 about μm, less than about 1 μm, or in ranges of about 500 nm to about 1 μm, about 750 nm to about 1.5 μm, about 1 μm to about 2 μm, about 1.5 μm to about 3 μm, about 2 μm to about 4 μm, about 3 μm to about 5 μm, about 4 μm to about 6 μm, about 5 μm to about 7 μm, about 6 μm to about 8 μm, about 7 μm to about 9 μm, or about 8 μm to about 10 μm. These relatively smaller spot sizes of the laser beam 222 are more likely to remove at least one cementing constituent from the cementing carbide substrate 212 at lower powers than laser beams 222 exhibiting larger spot sizes. These relatively small spot sizes may be formed by focusing the laser beam 222, for example, with at least one lens (not shown). However, it is noted that the spot size of the laser beam 222 may be larger than about 10 μm, such as in ranges of about 10 μm about 1 mm, about 25 μm to about 500 μm, about 50 μm to about 100 μm, about 40 μm to about 60 μm, about 1 mm or less, about 1 mm or more, or about 50 μm. Some of these larger spot sizes may be formed by defocusing the laser beam 222, for example, with at least one lens (not shown).

In an embodiment, the intensity or power of the laser 224 may be selected to cause at least one of the following: remove a selected amount of the at least one cementing constituent from the cemented carbide substrate 212, provide a desired amount of carbide grain growth, reduce the average diameter of the interstitial regions between the carbide grains by a desired amount, form a desired surface texture, or provide a desired chemical composition. In an example, the laser 224 may include a wattage of about 5 W or more, such as about 10 W to about 5 kW, about 20 W to about 100 W, about 10 W to about 30 W, about 30 W to about 50 W, or about 40 W to about 60 W. In an embodiment, the laser 224 may produce a laser beam 222 having a wavelength of about 400 nm or higher, such as about 400 nm to about 11 μm, about 1 μm to about 11 μm, about 1.05 μm to about 1.08 μm, or about 1.064 μm wavelength. In an embodiment, lasing the cemented carbide substrate 112 may include pulsing the laser 224 for at least about 10 ns, such as about 10 ns to about 300 ns, about 50 ns, to about 200 ns, about 75 ns to about 125 ns, about 90 ns to about 120 ns, or about 100 ns. In an embodiment, lasing the cemented carbide substrate may include using a pulse repetition rate of about 10 kHz to about 100 kHz, about 20 to about 80 kHz, about 10 to about 30 kHz, about 30 kHz to about 50 kHz, or about 40 kHz to about 60 kHz. The laser may include a scan speed of greater than about 1 inch/second (“in/s”), such as greater than about 10 in/s, greater than about 25 in/s, greater than about 50 in/s, greater than about 75 in/s, greater than about 100 in/s, greater than about 125 in/s, greater than about 150 in/s, or about 1 in/s to about 25 in/s, about 10 in/s to about 50 in/s, about 25 in/s to about 75 in/s, about 50 in/se to about 100 in/s, about 75 in/s to about 125 in/s, or about 100 in/s to about 150 in/s.

The peripheral surface 218 may be lased at any point after providing the superabrasive compact 200 (e.g., after forming the superabrasive compact 200). In an embodiment, as illustrated in FIG. 2, the peripheral surface 218 may be lased after providing the superabrasive compact 200 and before attaching the superabrasive compact 200 to a support body (e.g., a drill bit body, a support ring of a bearing assembly, etc.). In such an embodiment, for example, lasing the peripheral surface 218 may include rotating a superabrasive compact 200 while lasing the peripheral surface 218 with the laser beam 222 (e.g., a scanning laser beam) from the laser 224. For example, rotating the superabrasive compact 200 while lasing a portion thereof (e.g., peripheral surface 218 of the cemented carbide substrate 212) may include rotating the superabrasive compact 200 about a longitudinal axis L thereof in a rotary fixture while lasing at a fixed point, such that portions of the superabrasive compact 200 (e.g., different portions of the peripheral surface 218) are moved to the fixed point via rotation of the superabrasive compact 200. In an embodiment, the superabrasive compact 200 may rotate slightly off center, such that the lased portion of the superabrasive compact 200 exhibits an at least partially elliptical shape. In an embodiment, depending on the outer dimension of the superabrasive compact 200, the superabrasive compact 200 may be rotated at a speed of one rotation per minute or faster, such as one rotation every 10 seconds, one rotation every 22 seconds, one rotation every 24 seconds, or one rotation every 30 seconds. Each rotation of the superabrasive compact may include an over-rotation (e.g., overlap of rotation), such as an over-rotation of about 250 μm or more. In an embodiment, lasing may be carried out for only one rotation. In such embodiments, the height H of the corrosion-resistant layer 220 may be approximately the spot width of the laser beam 222. In an embodiment (not shown), lasing may be carried out over multiple rotations of the superabrasive compact 200. On each successive rotation, the laser 224 may be indexed to a longitudinally different position on of the peripheral surface 218 which may allow larger portions of the cemented carbide substrate 212 to be lased which may further result in a larger height H of the corrosion-resistant layer 220.

In an embodiment, after forming the superabrasive compact 200, the superabrasive compact 200 may be machined (e.g., subjected to a lapping or centerless grinding process) to a desired finish. In such an embodiment, the peripheral surface 218 may be lased after machining the superabrasive compact 200 since machining the superabrasive compact 200 may remove or reduce a thickness (e.g., thickness t shown in FIG. 1B) of the corrosion-resistant layer 220.

In an embodiment, after forming the superabrasive compact 200, the superabrasive compact 200 may be cleaned with flux or another cleaning agent that is selected to remove oxides from the superabrasive compact 200. For example, oxides on the superabrasive compact 200 may inhibit the superabrasive compact 200 from being brazed to a support body. As such, cleaning the superabrasive compact 200 with flux or another cleaning fluid may allow the superabrasive compact 200 to be brazed to the support body. However, as previously discussed, lasing the peripheral surface 218 may form one or more metal oxides which may improve the corrosion resistance of the cemented carbide substrate 212. As such, in some embodiments, the peripheral surface 218 may be lased after cleaning the superabrasive compact 200 with flux or another cleaning agent. However, in some embodiments, the peripheral surface 218 may be lased before cleaning the superabrasive compact 200 with flux or another cleaning agent. In such embodiments, the corrosion-resistant layer 220 may be masked such that the corrosion-resistant layer 220 is not exposed to the flux or other cleaning agent or the metal oxide (if present) may be removed from the corrosion-resistant layer 220 since the improved corrosion resistance of the corrosion-resistant layer 220 may not exclusively depend on the presence of the metal oxide.

In an embodiment, the peripheral surface 218 of the superabrasive compact 200 may be lased after attaching the superabrasive compact 200 to a support body (not shown). For example, metal oxides that are present in the corrosion-resistant layer 220 and other microstructures of the corrosion-resistant layer 220 may inhibit attaching (e.g., brazing) the superabrasive compact 200 to a support body, such as a drill bit body. As such, the superabrasive compact 200 may be attached to the support body before the corrosion-resistant layer 220 (e.g., a braze-resistant layer) is formed in the peripheral surface 218. However, attaching the superabrasive compact 200 to the support body may cause the support body to cover some of the peripheral surface 218 and leave a remainder of the peripheral surface 218 uncovered. Lasing the peripheral surface 218 after attaching the superabrasive compact 200 to the support body may only allow the uncovered portions of the superabrasive compact 200 to be exposed to the laser beam 222 and may cause the corrosion-resistant layer 220 to be formed thereon. Meanwhile, the covered portions of the peripheral surface 218 may not be exposed to the corrosive environment and, as such, may not need the corrosion-resistant layer 220 formed thereon.

Attaching the superabrasive compact 200 to the support body before lasing the superabrasive compact 200 may make maintaining a constant distance between the laser 224 and the peripheral surface 218 difficult. However, the difficulty may be overcome using a variety of techniques. In an example, the difficulty may be overcome by moving the laser 224 or laser beam 222 (e.g., by reflection via a mirror galvanometer) instead of merely moving the superabrasive compact 200. In an example, the difficulty may be overcome by increasing the distance between the peripheral surface 218 and the laser 224.

In an embodiment, lasing the peripheral surface 218 includes exposing one or more portions of the peripheral surface 218 to an oxidizing agent or atmosphere which may facilitate the formation of metal oxides during the lasing process. An oxidizing atmosphere can include an environment having one or more additional (e.g., non-ambient) oxidizing agents therein. For example, an oxidizing atmosphere may include an oxygen-enriched atmosphere (e.g., higher than ambient levels of O₂ gas), a halogen enriched atmosphere, an acidic fluid, exposure any other suitable oxidizing agent, or combinations of any of the foregoing.

In an embodiment, lasing the peripheral surface 218 may include heating one or more portions of the peripheral surface 218 of the cemented carbide substrate 212 to temperature of at least about 300° C., such as about 300° C. to about 1200° C., 400° C. to about 1000° C., about 500° C. to about 800° C., 600° C. to about 900° C., or at least about 700° C. Heating the peripheral surface 218 may increase the amount of carbide grain growth.

FIGS. 3A-3D are isometric views of superabrasive compacts, according to different embodiments. Each of the superabrasive compacts shown in FIGS. 3A-3D have corrosion-resistant layers (shown with texture to distinguish between the corrosion-resistant layers and other regions of the cemented carbide substrates) exhibiting different shapes. Except as otherwise disclosed herein the superabrasive compacts shown in FIGS. 3A-3D are the same as or substantially similar to any of the superabrasive compacts disclosed herein.

Referring to FIG. 3A, a superabrasive compact 300a includes a superabrasive body 302a and a cemented carbide substrate 312a. The cemented carbide substrate 312a includes at least one peripheral surface 318a and the corrosion-resistant layer 320a covers all of or substantially all of the peripheral surface 318a. As such, the corrosion-resistant layer 320a provides good corrosion resistance to all of the peripheral surface 318a. However, as previously discussed, the corrosion-resistant layer 320a may inhibit brazing of the superabrasive compact 300a to a support body (e.g., reduce braze strength or prevent bonding).

Referring to FIG. 3B, a superabrasive compact 300b includes a superabrasive body 302b and a cemented carbide substrate 312b. The cemented carbide substrate 312b includes an interfacial surface 314b bonded to the superabrasive body 302b, an opposing base surface 316b, and at least one peripheral surface 318b extending between the interfacial surface 314b and the base surface 316b. The cemented carbide substrate 312b also includes a corrosion-resistant layer 320b. The corrosion-resistant layer 320b includes (e.g., only includes) a generally annular portion extending from the interfacial surface 314b to a location between the interfacial surface 314b and the base surface 316b. The distance that the annular portion of the corrosion-resistant layer 320b extends from the interfacial surface 314b may be substantially constant (as shown) or may vary along the circumference of the cemented carbide substrate 312b.

The superabrasive compact 300b may be used in embodiments where the superabrasive compact is disposed in a recess defined by the support body (e.g., drill bit or bearing ring). The corrosion-resistant layer 320b may correspond to at least portions of the cemented carbide substrate 312b that are configured to extend from the recess. The portions of the peripheral surface 318b that do not include the corrosion-resistant layer 320b may be configured to be disposed in the recess. As such, the peripheral surface 318b provides a non-corrosion-resistant surface to be brazed to the recess and/or the support body covers the portions of the peripheral surface 318b that do not include the corrosion-resistant layer 320b.

Referring to FIG. 3C, a superabrasive compact 300c includes a superabrasive body 302c and a cemented carbide substrate 312c. The cemented carbide substrate 312c includes an interfacial surface 314c bonded to the superabrasive body 302c, an opposing base surface 316b, and at least one peripheral surface 318c extending between the interfacial surface 314c and the base surface 316c. The superabrasive compact 300c has a longitudinal axis (longitudinal axis L shown in FIG. 2) extending from the interfacial surface 314c to the base surface 316c. The cemented carbide substrate 312c also includes a corrosion-resistant layer 320c. The corrosion-resistant layer 320c includes (e.g., only includes) a longitudinally-extending portion extending from the interfacial surface 314c to the base surface 316c. The longitudinally-extending portion of the corrosion-resistant layer 320c does not extend circumferentially around the entire cemented carbide substrate 312c.

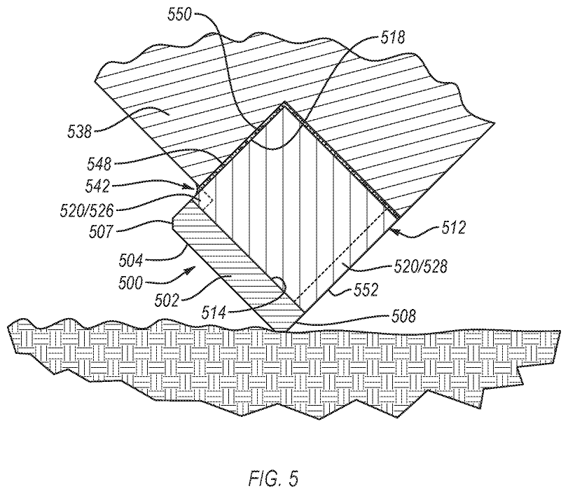

The superabrasive compact 300c may be used in embodiments where the superabrasive compact 300c is disposed in a pocket or recess (shown in FIG. 5) defined by the support body. The pocket or recess may leave a portion of the peripheral surface 318c exposed from a location at or near the base surface 316c to the interfacial surface 314c while covering an opposing portion of the peripheral surface 318c. The corrosion-resistant layer 320c may correspond to at least portions of the cemented carbide substrate 312b that are not adjacent to or not covered by the pocket or recess. The portions of the peripheral surface 318c that do not include the corrosion-resistant layer 320c may be configured to be covered by the pocket or recess. As such, the peripheral surface 318c provides a non-corrosion-resistant surface to be brazed to the pocket or recess and/or the cutout covers the portions of the peripheral surface 318c that do not include the corrosion-resistant layer 320c.

Referring to FIG. 3D, a superabrasive compact 300d includes a superabrasive body 302d and a cemented carbide substrate 312d. The cemented carbide substrate 312d includes an interfacial surface 314d bonded to the superabrasive body 302d, an opposing base surface 316d, and at least one peripheral surface 318d extending between the interfacial surface 314d and the base surface 316d. The superabrasive compact 300d has a longitudinal axis (longitudinal axis L shown in FIG. 2) extending from the interfacial surface 314d to the base surface 316d. The cemented carbide substrate 312d also includes a corrosion-resistant layer 320d. The corrosion-resistant layer 320d includes an annular portion 326 extending from the interfacial surface 314d to a location between the interfacial surface 314d and the base surface 316d and a longitudinally extending portion 328 extending from the interfacial surface 314d to the base surface 316d. It is noted that the annular portion 326 and the longitudinally extending portion 328 may overlap with each other.

The superabrasive compact 300d may be used in embodiments where the superabrasive compact 300d is disposed in a pocket or recess (shown in FIG. 5) defined by the support body. The pocket or recess may leave a portion of the peripheral surface 318d (corresponding to the longitudinally extending portion 328) exposed from a location at or near the base surface 316d to the interfacial surface 318d and have a portion of the peripheral surface 318d (corresponding to the annular portion 326) extending out the pocket or recess. The portions of the peripheral surface 318d that do not include the corrosion-resistant layer 320d may be configured to be covered by the pocket or recess. As such, the peripheral surface 318d provides a non-corrosion-resistant surface to be brazed to the pocket or recess and/or the pocket or recess covers the portions of the peripheral surface 318d that do not include the corrosion-resistant layer 320d.

In an embodiment, the superabrasive compacts disclosed herein may need to exhibit a selected orientation when the superabrasive compacts are attached to support bodies. For example, attaching the superabrasive compact to the support body while the superabrasive compact is incorrectly oriented may cause at least a portion of the corrosion-resistant layer to be adjacent to the support body (which may inhibit attaching the superabrasive compact to the support body) and/or a portion of the peripheral surface of the cemented carbide that does not include the corrosion-resistant layer may be exposed to a corrosive environment. However, correct orientation of the superabrasive compact may be difficult because the corrosion-resistant layer may be difficult to distinguish from portions of the peripheral surface of the cemented carbide substrate that does not include the corrosion-resistant layer.

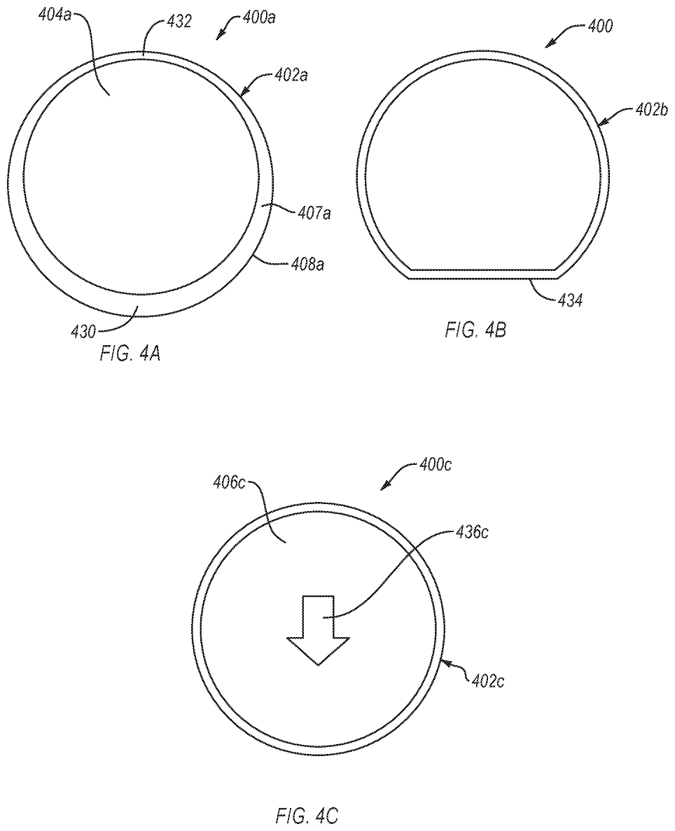

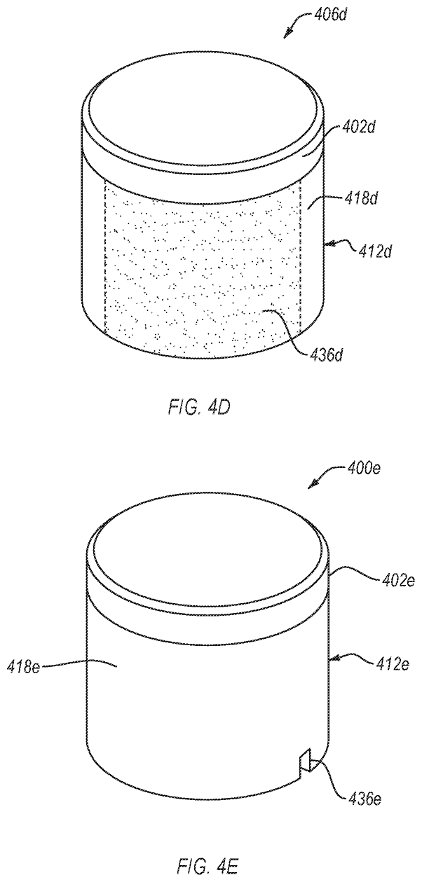

To facilitate orientation of the superabrasive compacts, the superabrasive compacts disclosed herein may include one or more features (e.g., visually detectable markings) thereon, especially when the corrosion-resistant layer is asymmetrical (e.g., the height H of the corrosion-resistant layer, as shown in FIG. 2 varies). FIGS. 4A-4E are views of different superabrasive compacts that include one or more features thereon, according to different embodiments. Except has otherwise disclosed herein, the superabrasive compacts illustrated in FIGS. 4A-4E may be the same or substantially similar to any of the superabrasive compacts disclosed herein. Additionally, the features illustrated in FIGS. 4A-4E may be used with any of the superabrasive compacts disclosed herein. Further, it is noted that the embodiments shown in FIGS. 4A-4E are merely examples of features that may be used and that the superabrasive compacts disclosed herein may include any suitable feature.

Referring to FIG. 4A, which is a top view of a superabrasive compact 400a, the superabrasive compact 400a includes a superabrasive body 402a. The superabrasive body 402a may include an upper surface 404a, at least one lateral surface 408a, and a chamfer 407a extending between the upper surface 404a and the lateral surface 408a. As illustrated the chamfer 407a exhibits a width that varies along a circumference of the superabrasive body 402a. For example, the chamfer 407a may include a thick portion 430 and a thin portion 432. The superabrasive compact 400a may include a corrosion-resistant layer (not shown) having a known orientation relative to the thick portion 430 and/or the thin portion 432 of the chamfer 407a. As such, the thick portion 430 and/or the thin portion 432 of the chamfer 407a may be used to orient the superabrasive compact 400a.

Referring to FIG. 4B, which is a top view of a superabrasive compact 400b, the superabrasive compact 400b includes a superabrasive body 402b. The superabrasive body 402b exhibits an asymmetrical cross-sectional shape, such as a truncated circular cross-sectional shape. The asymmetrical cross-sectional shape may facilitate orienting the superabrasive compact 400b. For example, the superabrasive body 402b may exhibit a generally planar portion 434. The corrosion-resistant layer (not shown) may exhibit a known location relative to the generally planar portion 434. As such, the location of the corrosion-resistant layer may be known when the generally planar portion 434 and, thus, may be used to orient the superabrasive compact 400b.

Referring to FIG. 4C, which is a top view of a superabrasive compact 400c, the superabrasive compact 400c includes a superabrasive body 402c. The superabrasive body 402c includes an upper surface 406c. The upper surface 406c may include one or more feature 436c formed thereon. The features 436c may include, for example, a recess formed on the upper surface 406c, a protrusion formed on the upper surface 406c, a visually detectable textured surface, or an image painted or printed on the upper surface 406c. The features 436c may include any suitable shape, such an arrow pointing in selected direction (e.g., the arrow points towards or away from the corrosion-resistant layer). The features 436c may be formed using any suitable method, such as forming the feature 436c with a laser.

It is noted that, while the feature 436c is illustrated on the upper surface 406c, the feature 436c may be located on any surface of the superabrasive compact 400c. For example, referring to FIG. 4D, which is an isometric view of a superabrasive compact 400d, the superabrasive compact 400d includes a superabrasive body 402d and a cemented carbide substrate 412d bonded to the superabrasive body 402d. The cemented carbide substrate 412d may include at least one peripheral surface 418d. The at least one peripheral surface 418d may include one or more features 436d formed thereon. The features 436d may include any of the features disclosed herein. The feature 436d may have a known location relative to the corrosion-resistant layer (not shown) thereby facilitating the orientation of the superabrasive compact 400d. The feature 436d may be formed on the corrosion-resistant layer or may be formed on a location of the peripheral surface 418d that does not include the corrosion-resistant layer. For example, the feature 436d may be formed on the corrosion-resistant layer when the feature 436d improves or has no effect on the corrosion resistance of the corrosion-resistant layer or may be formed on a location of the peripheral surface 418d that does not include the corrosion-resistant layer when the feature 436d would have an adverse effect on the corrosion resistance of the corrosion-resistant layer.

Referring to FIG. 4E, which is an isometric view of a superabrasive compact 400e that includes a superabrasive body 402e and a cemented carbide substrate 412e bonded to the superabrasive body 402e, according to an embodiment. The superabrasive body 402e may include at least one lateral surface 408e and the cemented carbide substrate 412e may include at least one peripheral surface 418e. In an embodiment, as shown, the peripheral surface 418e of the cemented carbide substrate 412e may include one or more features 436e formed therein. The one or more features 436e may include at least one notch. The feature 436 may be formed using a laser, grinding, electrical discharger machining, or any other suitable method The feature 436e may have a known location relative to the corrosion-resistant layer (not shown) thereby facilitating the orientation of the superabrasive compact 400e. In an embodiment, the feature 436e may be formed in the lateral surface 408e of the superabrasive body 402e instead of or in addition to the peripheral surface 418e of the cemented carbide substrate 412e.

FIG. 5 is a cross-sectional view of an application in a superabrasive compact 500 is attached to a support body 538, according to an embodiment. Except as otherwise disclosed herein, the superabrasive compact 500 may be the same or substantially similar to any of the superabrasive compacts disclosed herein. The support body 538 illustrated in FIG. 5 forms part of a drilling bit body or other material-removing device. However, it is noted that the support body 538 may include any other support body, such as a support ring of a bearing assembly.

In FIG. 5, the superabrasive compact 500 is being used to cut into an earth formation 540, such as a subterranean formation. To facilitate use of the superabrasive compact 500 in this manner, the superabrasive compact 500 is secured within a pocket or recess 542 or a recess (not shown) of a support body 538 (e.g., drill bit body). The support body 538 may move along the earth formation 540 and cut into the earth formation 540 using one or more of the upper surface 504, the lateral surface 508, or the chamfer 507 of the superabrasive body 502.

The superabrasive compact 500 may be secured within the pocket or recess 542 or recess in any suitable manner. For example, welding, mechanical fasteners, adhesives, or other processes or mechanisms may be used. Another process that may be used is brazing. Via brazing, the cemented carbide substrate 512 may be secured to one or more surfaces of the support body 538, which may also be formed of a metal, alloy, an infiltrated carbide material, or combinations thereof. A braze 548 (e.g., a braze material or alloy) may be heated to above a melting temperature thereof, and allowed to flow between the cemented carbide substrate 512 and the support body 538. Suitable braze alloys may be selected from gold alloys, silver alloys, iron-nickel alloys, copper alloys, silicon alloys, other suitable braze alloys containing additional metallic constituents (e.g., transition metals), or combinations of any of the foregoing. In an embodiment, the braze alloy may include Ticusil® available from MTC Wesgo Metals of Hayward, Calif. In an embodiment, the braze alloy may include about 50 weight % (“wt %”) silver, 20 wt % copper, 28 wt % zinc, and 2 wt % nickel, otherwise known as Silvaloy® A50N, which is currently commercially available from Wolverine Joining Technologies, LLC of Warwick, R.I. Other suitable braze alloys include AWS BAg-1 (44-46 wt % Ag, 14-16 wt % Cu, 14-18 wt % Zn, and 23-25 wt % Cd), AWS BAg-7 (55-57 wt % Ag, 21-23 wt % Cu, 15-19 wt % Zn, and 4.5-5.5 wt % Sn), and AWS BAg-24 (59-51 wt % Ag, 19-21 wt % Cu, 26-30 wt % Zn, and 1.5-2.5 wt % Ni), similar braze alloys, or equivalents thereof.

In some cases, the braze 548 may fill a clearance between the cemented carbide substrate 512 and support body 538 that is between about 0.03 mm to about 0.08 mm, although the clearance may be larger or smaller. For instance, the clearance may be between about 0.01 mm to about 1 mm. If the contact angle between droplets of the braze 548 and cemented carbide substrate 512 is sufficiently low, the liquid metal “wets” the cemented carbide substrate 512. Good wetting characteristics are typically desired for creation of high-quality brazed joints.

The cemented carbide substrate 512 includes at least one corrosion-resistant layer 520 formed on a peripheral surface 518. However, as previously discussed, the corrosion-resistant layer 520 may inhibit brazing the superabrasive compact 500 to the support body 538. As such, the corrosion-resistant layer 520 may substantially only be formed on portions of the peripheral surface 518 that are not adjacent to the pocket or recess 542. However, as illustrated, a small portion of the corrosion-resistant layer 520 may be configured to contact the braze 548 to form an overlap between the corrosion-resistant layer 520 and the braze 548. The overlap between the corrosion-resistant layer 520 and the braze 548 may prevent portions of the peripheral surface 518 that do not include the corrosion-resistant layer 520 from being exposed to a corrosive environment.

The pocket or recess 542 of the support body 538 may be configured to cover a first portion 550 of the peripheral surface 518 while not covering an opposing second portion 552 of the peripheral surface 518. As such, the corrosion-resistant layer 520 may include an annular portion 526 that extends from an interfacial surface 514 to the first portion 550 of the peripheral surface 518 and a longitudinally-extending portion 528 covering the second portion 552 of the peripheral surface 518.

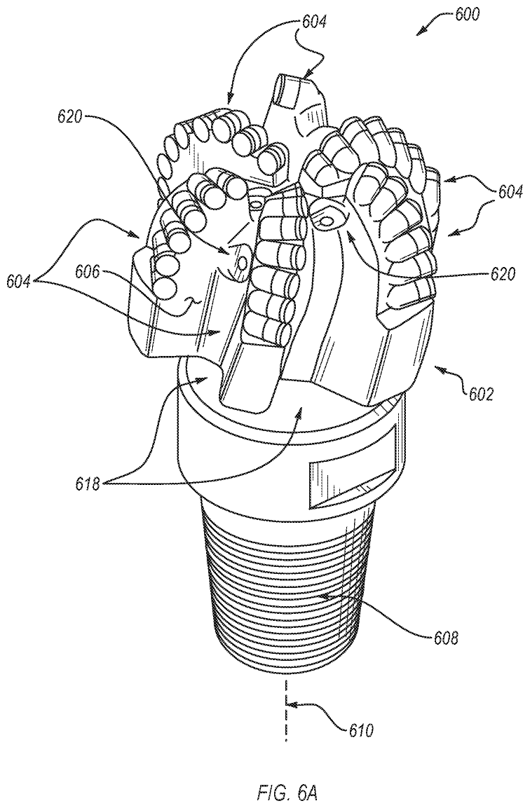

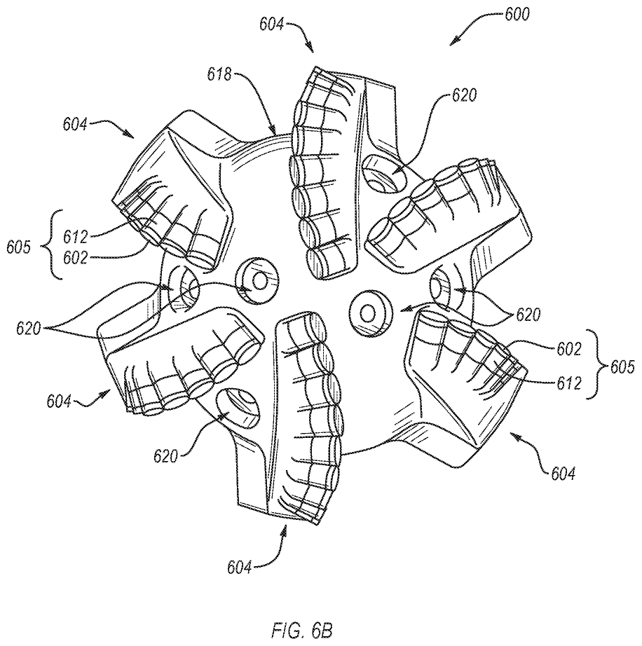

The superabrasive compact according to any of the foregoing embodiments may be attached to any suitable support body and used in a variety of applications, such as rotary drill bits in drilling applications. FIG. 6A is an isometric view and FIG. 6B is a top elevation view of an embodiment of a rotary drill bit 600, according to an embodiment. The rotary drill bit 600 includes at least one superabrasive compact, such as a PDC, which may be usable as a superabrasive cutting element 605 which may comprise any features of superabrasive compacts disclosed herein, in any combination, without limitation. The rotary drill bit 600 comprises a bit body 601 that includes radially-extending and longitudinally-extending blades 604 with leading faces 606, and a threaded pin connection 608 for connecting the bit body 601 to a drilling string. The bit body 601 defines a leading end structure for drilling into a subterranean formation by rotation about a longitudinal axis 609 and application of weight-on-bit.

At least one superabrasive cutting element 605 may be configured according to any of the previously described superabrasive compact embodiments may be affixed to the bit body 601. According to some embodiments herein, the at least one superabrasive cutting element 605 is disposed within a corresponding pocket or recess formed in the bit body 601. For example, pocket or recess may be blind holes, cutouts, or another suitable receptacle formed in the bit body 601, and the substrate portion of the superabrasive cutting elements 605 may be sized to generally correspond to the size the recesses. With reference to FIG. 6B, each of a plurality of cutting elements 605 is disposed within a corresponding one of the pockets or recesses of the blades 604.

More particularly, the rotary drill bit 600 shown in FIGS. 6A and 6B may be fabricated by positioning the superabrasive cutting elements 605 in a corresponding one of the pockets or recesses formed in the bit body 601, followed by subjecting the bit body 601, the superabrasive cutting elements 605, and braze alloy to a suitable braze processes that include temperature cycles that melt and cause the braze alloy to flow so that so that a strong metallurgical bond is formed between a substrate 612 of the superabrasive cutting element 605 and the bit body 601 upon cooling. The brazing temperature depends, at least in part, on the liquidus temperature of the braze alloy. For example, typically, the brazing temperature may be about 600° C. to 1050° C., such as about 600° C. to about 750° C.

Each cutting element 605 may include a superabrasive body 602 bonded to the substrate 612. More generally, the cutting elements 605 may comprise any superabrasive compact disclosed herein, without limitation. In addition, if desired, in some embodiments, a number of the cutting elements 605 may be conventional in construction. Also, circumferentially adjacent blades 604 may define so-called junk slots 618 therebetween, as known in the art. Further, the rotary drill bit 600 may include a plurality of nozzle cavities 620 for communicating drilling fluid from the interior of the rotary drill bit 600 to the cutting elements 605.

FIGS. 6A and 6B merely depict one embodiment of a rotary drill bit 600 that employs at least one cutting element that comprises a superabrasive compact suitable for analysis and fabrication in accordance with the disclosed embodiments, without limitation. The rotary drill bit 600 is used to represent any number of earth-boring tools or drilling tools, including, for example, core bits, roller cone bits, fixed cutter bits, eccentric bits, bicenter bits, reamers, reamer wings, or any other downhole tool including superabrasive compacts or PDCs, without limitation.

The superabrasive compacts disclosed herein may also be utilized in applications other than cutting technology. For example, the disclosed superabrasive compact embodiments may be used in wire dies, bearings, artificial joints, inserts, cutting elements, and heat sinks. Thus, any of the superabrasive compacts disclosed herein may be employed in an article of manufacture including at least one superabrasive element or compact.

Thus, the embodiments of superabrasive compacts disclosed herein may be used in any apparatus or structure in which at least one conventional PDC is typically used. In one embodiment, a rotor and a stator, assembled to form a thrust-bearing apparatus, may each include one or more superabrasive compacts configured according to any of the embodiments disclosed herein and may be operably assembled to a downhole drilling assembly. U.S. Pat. Nos. 4,410,054; 4,560,014; 5,364,192; 5,368,398; and 5,480,233, the disclosure of each of which is incorporated herein, in its entirety, by this reference, disclose subterranean drilling systems within which bearing apparatuses utilizing superabrasive compacts disclosed herein may be incorporated. The embodiments of superabrasive compacts disclosed herein may also form all or part of heat sinks, wire dies, bearing elements, cutting elements, cutting inserts (e.g., on a roller-cone-type drill bit), machining inserts, or any other article of manufacture as known in the art. Other examples of articles of manufacture that may use any of the superabrasive compacts disclosed herein are disclosed in U.S. Pat. Nos. 4,811,801; 4,268,276; 4,468,138; 4,738,322; 4,913,247; 5,016,718; 5,092,687; 5,120,327; 5,135,061; 5,154,245; 5,180,022; 5,460,233; 5,544,713; and 6,793,681, the disclosure of each of which is incorporated herein, in its entirety, by this reference.

### WORKING EXAMPLES

The following working example sets forth a method for forming LME-resistant PDCs. The following working example provides further detail in connection with the specific embodiments described above.

### Comparative Example 1

Five superabrasive compacts that included a PCD table bonded to a cemented tungsten carbide substrate were provided and weighed. The cemented carbide substrate of each of the superabrasive compacts exhibited an average grain size of about 2.8 μm, a tungsten carbide content of about 87 wt. %, and a cobalt content of about 13 wt. %.

Without lasing any of the superabrasive compacts, each of the superabrasive compacts was subjected to a corrosion test. The corrosion test included providing a buffered saline solution. The buffered saline solution included 2 molar (“M”) NaCl and 0.2 M Na₃PO₄ and exhibited a pH of about 5.6 and a conductivity of 155 milli-siemens. 50 ml of the buffered saline solution was placed in a container that included one of the superabrasive compacts as a working electrode, a platinum wire counter electrode, and a silver/silver chloride reference electrode. The superabrasive compact was electrically contacted with the platinum wire. An oxidative potential of about 0.2 volts was applied to each of the superabrasive compacts for a period of time. Each of the superabrasive compacts was then removed from the buffered saline solution and grit blasted with silicon oxide for 30 seconds. After grit blasting, the mass of each of the superabrasive compacts was measured.

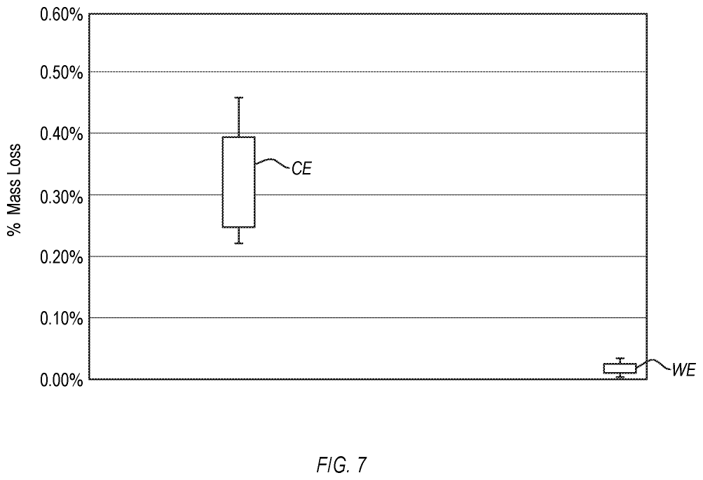

The mass loss of the superabrasive compacts during the corrosion test is related directly to the rate of corrosion of the superabrasive compacts. The mass loss of the five superabrasive compacts of comparative example 1 are shown in FIG. 7 (indicated with CE).

### Working Example 1

Five superabrasive compacts were provided that, initially, were the same as the five superabrasive compacts of comparative example 1. Each of the superabrasive compacts had an entirety of the peripheral surfaces of the cemented carbide substrates thereof lased to form a corrosion-resistant layer. The peripheral surface of the cemented carbide substrates were lased by positioning the peripheral surfaces of the substrates proximate to a laser and emitting a scanning laser beam at the peripheral surfaces at a power of 50 watts, a scan speed of 100 inches/second, and a frequency of 50 kHz. Each of the superabrasive compacts of working example 1 were then subjected to the same corrosion test described in comparative example 1.

The mass of each of the superabrasive compacts were measured before and after the corrosion test. The mass loss of the superabrasive compacts of working example 1 are shown in FIG. 7 (indicated with WE). As shown in FIG. 7, the five superabrasive compacts of working example 1 exhibited a mass loss that was significantly less than the mass loss of the five NOV 10 superabrasive compacts of comparative example 1. As such, FIG. 7 demonstrates that lasing the peripheral surfaces may increase the corrosion-resistance of the superabrasive compacts.

### Working Example 2

A cobalt-cemented tungsten carbide substrate was provided. The tungsten carbide of the cobalt-cemented tungsten carbide substrate initially substantially only included tungsten carbide grains exhibiting a chemical formula of WC in a cobalt matrix. An entirety of the peripheral surfaces of the cobalt-cemented tungsten carbide substrate was lased to form a corrosion-resistant layer. The peripheral surface was lased by positioning the peripheral surface of the cobalt-cemented tungsten carbide substrate proximate to a laser and emitting a scanning laser beam at the peripheral surface at a power of 50 watts, a scan speed of 100 inches/second, and a frequency of 50 kHz. The as-formed corrosion-resistant layer of the cobalt cemented tungsten carbide substrate was then examined using an X-ray diffraction emitting a copper k-alpha x-ray beam exhibiting a wavelength of 1.5406 angstroms. It is estimated that depth that the X-rays entered the corrosion-resistant layer was about 4 μm.

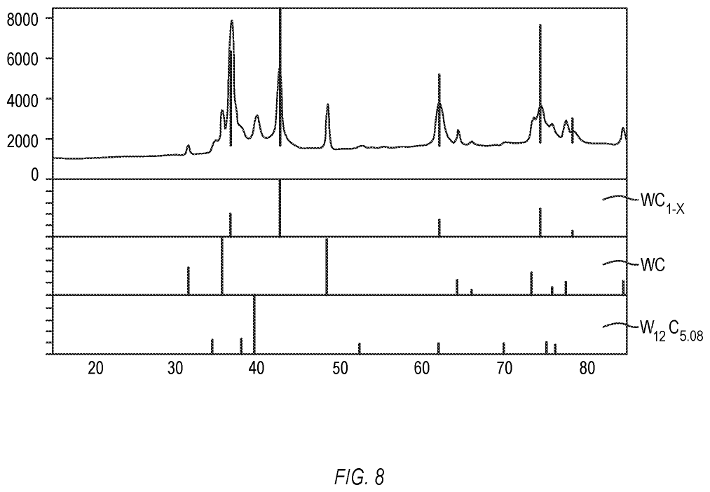

FIG. 8 is a graph of the results of the examination of the corrosion-resistant layer with X-ray diffraction. The graph demonstrated that the corrosion-resistant layer included tungsten carbide exhibiting the chemical formula of WC₁₋ₓ and W₁₂C_{5.08} in addition to tungsten carbide exhibiting the chemical formula of WC. Further, the corrosion-resistant layer did not include any detectable cobalt catalyst in the analyzed portions of the corrosion-resistant layer.

### Comparable Example 2

Three superabrasive compacts that were substantially the same as the superabrasive compacts of comparative example 1 were provided and weighed. Then, each of the three superabrasive compacts were immersed in a 15.6 M nitric acid solution for six hours without masking or otherwise protecting the tungsten carbide substrate of the superabrasive compacts from the nitric acid solution. Each of the three superabrasive compacts were weighed after removing the three superabrasive compacts from the nitric acid solution. Weighing the superabrasive compacts demonstrated that the nitric acid solution dissolved an average of 0.14 wt. % of the three superabrasive compacts.

### Working Example 3

Three superabrasive compacts that were the same as the superabrasive compacts of comparative example 1 were provided. Each of the three superabrasive compacts were lased to form a corrosion-resistant layer on all of the exposed surfaces of the substrates thereof. Initially, each of the three superabrasive compacts were weighed. Then, each of the three superabrasive compacts were immersed in a 15.6 M nitric acid solution for six hours without masking or otherwise protecting the tungsten carbide substrate from the nitric acid solution. The three superabrasive compacts were weighed after removing the three superabrasive compacts from the nitric acid solution. Weighing the superabrasive compacts demonstrated that the nitric acid solution dissolved an average of 0.01 wt. % of the three superabrasive compacts.

Comparing the three superabrasive compacts of comparative example 2 and the three superabrasive compacts of working example 3 demonstrated that corrosion-resistant layer of the superabrasive compacts of working example 3 significantly inhibited corrosion of the three superabrasive compacts of working example 3. Working example 3 also demonstrated that the corrosion-resistant layers disclosed herein may enable the superabrasive compacts disclosed herein to be leached without masking or otherwise protecting the tungsten carbide substrates or can minimize damage caused by inadvertently exposing the tungsten carbide substrates to the acid.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A superabrasive compact, comprising:
a superabrasive body including an upper surface, a bonding surface, and at least one lateral surface extending between the upper surface and the bonding surface; and
a cemented carbide substrate including at least one cementing constituent, the cemented carbide substrate including:
a base surface;
an interfacial surface bonded to the bonding surface of the superabrasive body;
at least one peripheral surface extending between the base surface and the interfacial surface; and
a corrosion-resistant layer extending inwardly from a portion of the at least one peripheral surface, the corrosion-resistant layer including a lower concentration of the at least one cementing constituent than portions of the cemented carbide substrate that are spaced from the corrosion-resistant layer.

2. The superabrasive compact of claim 1 wherein the superabrasive body includes a polycrystalline diamond table.

3. The superabrasive compact of claim 1 wherein the cemented carbide substrate includes a cobalt-cemented tungsten cemented carbide substrate.

4. The superabrasive compact of claim 1 wherein the corrosion-resistant layer is substantially free of the at least one cementing constituent to a depth that extends at least about 4 μm from the at least one peripheral surface.

5. The superabrasive compact of claim 1 wherein the corrosion-resistant layer includes one or more metal oxides.

6. The superabrasive compact of claim 1 wherein the corrosion-resistant layer includes tungsten carbide having a chemical formula of WC₁₋ₓ, where x is less than 1.

7. The superabrasive compact of claim 1 wherein the corrosion-resistant layer extends at least about 10 μm inwardly from the at least one peripheral surface.

8. The superabrasive compact of claim 1 wherein the corrosion-resistant layer asymmetrically covers the at least one peripheral surface.

9. The superabrasive compact of claim 8, further comprising one or more features that facilitate orienting the superabrasive compact.

10. The superabrasive compact of claim 1 wherein the corrosion-resistant layer includes an annular portion extending from the interfacial surface to a location between the interfacial surface and the base surface.

11. The superabrasive compact of claim 1 wherein the corrosion-resistant layer includes a longitudinally-extending portion extending from a portion of the interfacial surface to a corresponding portion of the base surface.

12. The superabrasive compact of claim 1 wherein the corrosion-resistant layer exhibits a rate of penetration that is at least two times less than portions of the at least one peripheral surface that are spaced from the corrosion-resistant layer as determined by a corrosion test;
wherein the corrosion test includes:
measuring an initial mass of the cemented carbide substrate;
using an oxidative assay to expose the corrosion-resistant layer of the cemented carbide substrate to oxidative and/or corrosive environments and;
after using an oxidative assay; measuring a final mass of the cemented carbide substrate.

13. The superabrasive compact of claim 1 wherein the corrosion-resistant layer exhibits a rate of penetration that is at least ten times less than portions of the at least one peripheral surface that are spaced from the corrosion-resistant layer as determined by a corrosion test;
wherein the corrosion test includes:
measuring an initial mass of the cemented carbide substrate;
using an oxidative assay to expose the corrosion-resistant layer of the cemented carbide substrate to oxidative and/or corrosive environments and;
after using an oxidative assay; measuring a final mass of the cemented carbide substrate.

14. A method of making a corrosion-resistant superabrasive compact, the method comprising:
providing a superabrasive compact, the superabrasive compact including:
a superabrasive body having an upper surface, a bonding surface, and at least one lateral surface extending between the upper surface and the bonding surface; and
a cemented carbide substrate having a base surface, an interfacial surface bonded to the bonding surface, and at least one peripheral surface extending between the base surface and the interfacial surface, the cemented carbide substrate including at least one cementing constituent; and
lasing a portion of the at least one peripheral surface of the cemented carbide substrate to form a corrosion-resistant layer extending into the at least one peripheral surface, the corrosion-resistant layer including a lower concentration of the at least one cementing constituent than portions of the cemented carbide substrate that are spaced from the corrosion-resistant layer.

15. The method of claim 14 wherein lasing a portion of the at least one peripheral surface of the cemented carbide substrate to form a corrosion-resistant layer includes forming an annular portion of the corrosion-resistant layer that extends from the interfacial surface to a location between the interfacial surface and the base surface.

16. The method of claim 14 wherein lasing a portion of the at least one peripheral surface of the cemented carbide substrate to form a corrosion-resistant layer includes forming a longitudinally extending portion of the corrosion-resistant layer that extends from a portion of the interfacial surface to the base surface.

17. The method of claim 14 wherein lasing a portion of the at least one peripheral surface of the cemented carbide substrate includes emitting a laser beam exhibiting a spot size of less than 10 μm.

18. The method of claim 14, wherein lasing a portion of the at least one peripheral surface of the cemented carbide substrate includes emitting a laser beam at a power of 40 watts to 60 watts, a line-scan speed of 75 inches/second to about 125 inches/second, and a frequency of about 40 kHz to about 60 kHz.

19. The method of claim 14, further comprising, attaching the superabrasive compact to a bit body.

20. The method of claim 19, wherein the superabrasive compact is attached to the bit body before lasing the portion of the at least one peripheral surface of the cemented carbide substrate.

21. The method of claim 19, wherein the superabrasive compact is attached to the bit body after lasing the portion of the at least one peripheral surface of the cemented carbide substrate.

22. The method of claim 14, further comprising machining at least a portion of the at least one peripheral surface of the cemented carbide substrate before lasing the portion of the at least one peripheral surface of the cemented carbide substrate.

23. The method of claim 14, further comprising removing one or more oxides from the at least one peripheral surface with flux or another cleaning agent before lasing the portion of the at least one peripheral surface of the cemented carbide substrate.

24. The method of claim 14, further comprising forming one or more features on the superabrasive compact configured to orient the superabrasive compact.

25. The method of claim 24, further comprising:
orienting the superabrasive compact with the one or more features relative to a support body; and
after orienting the superabrasive compact with the one or more markers relative to the support body, attaching the superabrasive compact to the support body such that the support body does not cover at least a portion of the corrosion-resistant layer and the support body covers at least a portion of the at least one peripheral surface that does not include the corrosion-resistant layer.

26. A drill bit comprising:
a bit body; and
a superabrasive compact attached to the bit body, the superabrasive compact including:
a superabrasive body including an upper surface, a bonding surface, and at least one lateral surface extending between the upper surface and the bonding surface; and
a cemented carbide substrate including at least one cementing constituent, the cemented carbide substrate including:
a base surface;
an interfacial surface bonded to the bonding surface of the superabrasive body;
at least one peripheral surface extending between the base surface and the interfacial surface; and
a corrosion-resistant layer extending inwardly from at least portions of the at least one peripheral surface that are not covered by the bit body, the corrosion-resistant layer including a lower concentration of the at least one cementing constituent than portions of the cemented carbide substrate that are spaced from the corrosion-resistant layer.
